(19) United States
(12) Patent Application Publication
(10) Pub. No.: US 2024/0403855 A1
(43) Pub. Date: Dec. 5, 2024

(54) SETTLEMENT DEVICE AND METHOD FOR SETTLEMENT DEVICE

(71) Applicant: Toshiba Tec Kabushiki Kaisha, Tokyo (JP)

(72) Inventor: Ichiro FUKUZAWA, Ota Tokyo (JP)

(21) Appl. No.: 18/617,543

(22) Filed: Mar. 26, 2024

(30) Foreign Application Priority Data
May 30, 2023 (JP) 2023-088406

(51) Int. Cl. G06Q 20/22; G06Q 40/04

(52) U.S. Cl. CPC G06Q 20/227; G06Q 40/04

(57) ABSTRACT

According to one embodiment, a settlement computing device includes a first display device capable of displaying information relevant to store clerks for settling transactions with customers; a second display device capable of displaying information relevant to the customers for settling the transactions; and a processor configured to: acquire identifying information about a commodity to be purchased by a first customer as part of a first transaction; and after acquiring the first information: cause the first display device to display a total price required from the first customer as payment to complete the first transaction; cause the second display device to display a first amount of money deposited by the first customer, without causing the first display device to display the first amount of money; and determine whether a total amount of money deposited by the first customer is sufficient for settling the first transaction.

### CROSS-REFERENCE TO RELATED APPLICATION

This application is based upon and claims the benefit of priority from Japanese Patent Application No. 2023-088406, filed May 30, 2023, the entire contents of which are incorporated herein by reference.

### FIELD

Embodiments described herein relate generally to a settlement device and a method therefor.

### BACKGROUND

There is a commodity sales system used sometimes for larger retail stores such as supermarkets and home improvement centers sometimes referred to as a “two-man system.” Such a two-man commodity sales system includes an input device operated by a first store clerk (called a “checker”) and a settlement device operated by a second store clerk (called a “cashier”). The input device used by the checker is equipment for inputting information relating to a commodity to be purchased (also referred to as a “purchase commodity”) such as a barcode attached to a commodity. The settlement device used by the cashier is equipment for processing sales data of the purchase commodity based on the information input by the checker via the input device and is used for settling (receiving payments for) a transaction with a customer. In the two-person commodity sales system, since the input device and the settlement device are physically separate, the input device can begin input of information relating to a purchase commodity of a second customer while the settlement device is still processing settlement for a first customer. Therefore, it is possible to more efficiently provide service to customers.

However, in recent years, from the viewpoint of reducing personnel expenses, implementing infection control measures, and the like, it has become common to require a customer himself or herself to perform an operation to manage a payment for settling a transaction. Such a modified two-person commodity sales system (sometimes referred to as a semi-self-service system) requires a customer himself or herself to perform an operation to perform the payment using the settlement device. Consequently, since the cashier is unnecessary, personnel expenses can be reduced. Since a store clerk does not handle the customer's cash, credit card, and the like, infection control is improved. However, if the cashier is absent, the checker has to answer any inquiry from a customer who is performing settlement. In that case, it is desired that the store clerk (checker) can check information concerning a customer before settlement.

### DESCRIPTION OF THE DRAWINGS

FIG. 1 is a schematic configuration diagram of a commodity sales system according to an embodiment.

FIG. 2 is a schematic configuration diagram of a settlement device.

FIG. 3 is a schematic diagram illustrating aspects of a main memory of a settlement device.

FIG. 4 is a block diagram illustrating functional aspects of a processor of a settlement device.

FIG. 5 is a flowchart illustrating first information processing executed by a processor.

FIG. 6 is a flowchart illustrating second information processing executed by a processor.

FIG. 7 is a flowchart illustrating second information processing.

FIG. 8 is an example of a registration screen displayed on a touch panel of an input device.

FIG. 9 is an example of a registration screen displayed on a display of an input device.

FIG. 10 is an example of a subtotal screen displayed on a touch panel.

FIG. 11 is an example of a first notification screen displayed on a display.

FIG. 12 is an example of a second notification screen displayed on a display.

FIG. 13 is an example of a total screen displayed on a first touch panel of a settlement device.

FIG. 14 is a schematic diagram illustrating a transition example of information displayed in a second customer area of a total screen.

FIG. 15 is an example of a payment method selection screen displayed on a second touch panel of a settlement device.

FIG. 16 is an example of a payment method selection screen displayed on a first touch panel.

FIG. 17 is an example of a store clerk operation-in-progress screen displayed on a second touch panel.

FIG. 18 is an example of a payment support screen for cash payment displayed on a second touch panel.

FIG. 19 is an example of a payment check screen for cash payment displayed on a second touch panel.

FIG. 20 is an example of a payment completion screen displayed on a first touch panel.

FIG. 21 is an example of a payment completion screen displayed on a second touch panel.

FIG. 22 is an example of a payment support screen for credit card payment displayed on a second touch panel.

FIG. 23 is an example of a payment check screen for credit card payment displayed on a second touch panel.

FIG. 24 is an example of a payment support screen for electronic money payment displayed on a second touch panel.

FIG. 25 is an example of a payment check screen for electronic money payment displayed on a second touch panel.

FIG. 26 is a diagram illustrating transition of screens respectively displayed on a first touch panel and a second touch panel when a customer performs price payment operation by himself or herself.

FIG. 27 is a diagram illustrating transitions of screens respectively displayed on a first touch panel and a second touch panel when a store clerk performs a selection operation for a price payment method instead of the customer.

### DETAILED DESCRIPTION

Certain embodiments describe a settlement device that enables a store clerk to check information related to a customer before customer settlement processing starts for a transaction in a commodity sales system including an input device and a settlement device for a semi-self-service point-of-sale system.

In general, according to one embodiment, a settlement computing device includes a first display device capable of displaying information relevant to store clerks for settling transactions with customers; a second display device capable of displaying information relevant to the customers for settling the transactions; and a processor configured to: acquire identifying information about a commodity to be purchased by a first customer as part of a first transaction; and after acquiring the first information: cause the first display device to display a total price required from the first customer as payment to complete the first transaction; cause the second display device to display a first amount of money deposited by the first customer, without causing the first display device to display the first amount of money; and determine whether a total amount of money deposited by the first customer is sufficient for settling the first transaction.

Certain example embodiments of a settlement device will be explained with reference to the drawings.

### Explanation of a Configuration of a Commodity Sales System

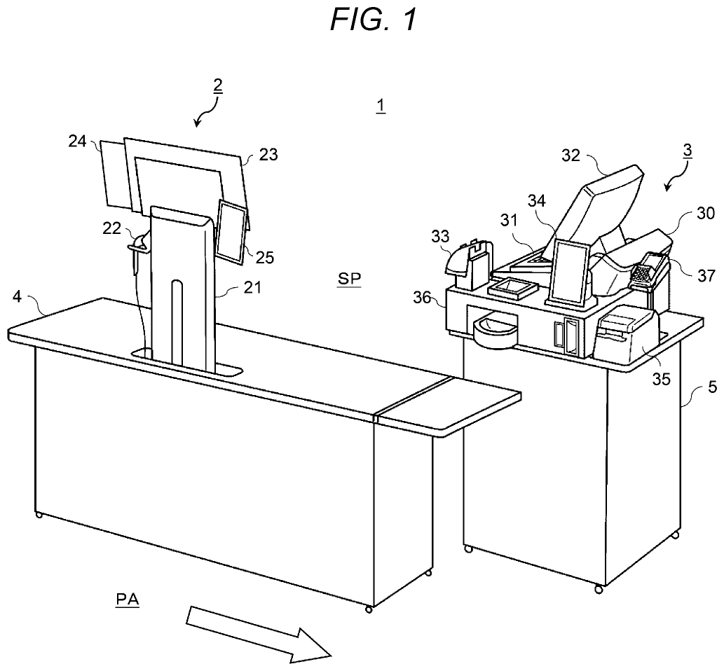

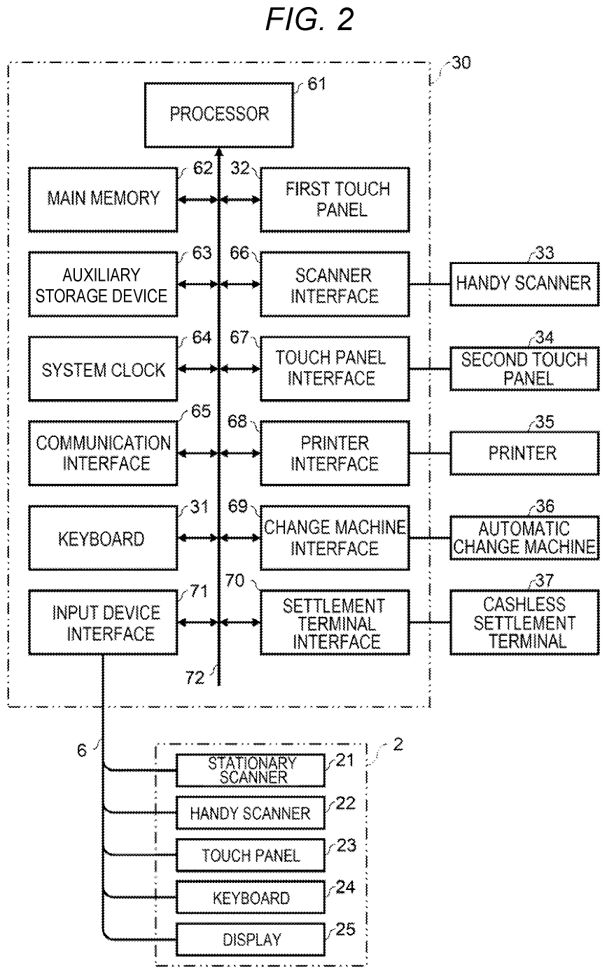

FIG. 1 is a schematic configuration diagram of a commodity sales system 1 according to an embodiment. The commodity sales system 1 includes an input device 2 and a settlement device 3. The input device 2 and the settlement device 3 are connected by a transmission cable 6 (see FIG. 2) such as a LAN (Local Area Network) cable.

The input device 2 is attached to a checkout counter 4. The checkout counter 4 is disposed along a checkout lane PA on which a customer, who is a purchaser, walks to move in a direction of an illustrated arrow. The input device 2 is attached to substantially the center of the top surface of the checkout counter 4. A space further on an upstream side of the checkout lane PA than the input device 2 is set as a space for placing a purchase commodity before input of a commodity code. A space on a downstream side of the checkout lane PA than the input device 2 is set as a space for placing the purchase commodity after the input of the commodity code. The input device 2 is a device for inputting a commodity code and the like attached to the purchase commodity. The settlement device 3 is a device for storing, in a main memory 62, information concerning the purchase commodity, the commodity code and the like of which were input by the input device 2. Storing the information concerning the purchase commodity in the main memory 62 in this way is referred to as registration of the purchase commodity. The settlement device 3 performs settlement of a transaction based on the information concerning the purchase commodity registered in the main memory 62.

The input device 2 includes a stationary scanner 21, a handy scanner 22, a touch panel 23, a keyboard 24, and a display 25 as input and output devices. In the input device 2, the stationary scanner 21 is disposed to project upward from the top surface of the checkout counter 4 and the handy scanner 22, the touch panel 23, the keyboard 24, and the display 25 are disposed around the stationary scanner 21.

Specifically, in the input device 2, the stationary scanner 21 is fixed to the top surface of the checkout counter 4. The stationary scanner 21 is vertical and is fixed such that a barcode reading window is located on a surface on the opposite side of the checkout lane PA. In the input device 2, the handy scanner 22 is locked to one side section of the stationary scanner 21. The touch panel 23 is attached to an upper part of the stationary scanner 21 such that an operation panel surface of the touch panel 23 faces the same direction as the reading window of the stationary scanner 21. The keyboard 24 is attached to one side section of the touch panel 23 such that a key surface of the keyboard 24 faces the same direction as the operation panel surface of the touch panel 23. Further, the display 25 is attached to one side section of the stationary scanner 21 such that a display screen of the display 25 faces the side of the checkout lane PA. Note that the display 25 may be a touch panel.

With the disposition of the input and output devices explained above, a store clerk standing in a space SP on the opposite side of the checkout lane PA across the checkout counter 4 can operate the stationary scanner 21, the handy scanner 22, the touch panel 23, or the keyboard 24 and input information relating to a purchase commodity to be purchased by a customer, for example, a commodity code, a purchase quantity, a price-cut amount, and the like. At this time, the store clerk can check a commodity name, a unit price, and the like of the purchase commodity from the information displayed on the touch panel 23. The customer can check the commodity name, the unit price, and the like of the purchase commodity from the information displayed on the display 25. If the customer presents a barcode of the electronic receipt ID displayed on a smartphone or the like, the store clerk reads the barcode using the handy scanner 22. Consequently, data of the electronic receipt ID is input. A receipt indicating details of a commercial transaction with the customer is dispensed in a form of an electronic receipt.

The settlement device 3 includes a keyboard 31 and a first touch panel 32 as devices integrated with a device main body 30. The settlement device 3 includes a handy scanner 33, a second touch panel 34, a printer 35, an automatic change machine 36, and a cashless settlement terminal 37 as devices externally attached to the device main body 30. The settlement device 3 is placed on the top surface of a register counter 5 installed on the opposite side of the checkout lane PA near a downstream side end portion in the checkout counter 4.

Specifically, in the settlement device 3, the device main body 30 is placed on the register counter 5 such that a key surface of the keyboard 31 and an operation panel surface of the first touch panel 32 face the side of the space SP where the store clerk stands. The handy scanner 33, the second touch panel 34, the printer 35, the automatic change machine 36, and the cashless settlement terminal 37 are disposed around the device main body 30. The handy scanner 33 is disposed in a position where the store clerk standing in the space SP is capable of operating the handy scanner 33. The second touch panel 34 is disposed in a position where the customer standing in the checkout lane PA is capable of viewing a display surface of the second touch panel 34. The printer 35 is disposed in a position where the customer standing in the checkout lane PA can easily receive a receipt.

The automatic change machine 36 is equipment including a function of counting bills or coins deposited from a depositing port and calculating a deposited amount, a function of sorting deposited cash for each of a plurality of denominations and storing the cash in a safe, and a function of taking out bills or coins equivalent to a change amount from the safe and dispensing the bills or the coins to a dispensing port. The automatic change machine 36 is disposed in a position where the customer standing in the checkout lane PA can easily deposit money and take out dispensed change.

The cashless settlement terminal 37 is equipment specialized for processing cashless settlement such as credit card settlement, electronic money settlement, and code settlement. The cashless settlement terminal 37 is disposed in a position where the customer standing in the checkout lane PA can easily operate the cashless settlement terminal 37 if performing cashless settlement such as credit card settlement, electronic money settlement, and code settlement.

In the disposition of the devices explained above, an operator of the keyboard 31, the first touch panel 32, and the handy scanner 33 is the store clerk. An operator of the second touch panel 34, the printer 35, the automatic change machine 36, and the cashless settlement terminal 37 is the customer. That is, the first touch panel 32 functions as a display unit for store clerks that displays information to the store clerk. The second touch panel 34 functions as a display unit for customers that displays information to the customer.

In general, in a large retail store such as a supermarket or a home improvement center, a plurality of commodity sales systems I having the configuration explained above are installed in parallel in a checkout place separate from a selling floor where commodities are displayed. In a small retail store such as a specialty store, sometimes only one commodity sales system 1 is installed in the store.

### Explanation of a Configuration of the Settlement Device

FIG. 2 is a schematic configuration diagram of the settlement device 3. As illustrated in FIG. 2, the settlement device 3 includes, in the device main body 30, a processor 61, a main memory 62, an auxiliary storage device 63, a system clock 64, a communication interface 65, a scanner interface 66, a touch panel interface 67, a printer interface 68, a change machine interface 69, a settlement terminal interface 70, and an input device interface 71 as components. The processor 61 and the main memory 62, the auxiliary storage device 63, the system clock 64, the communication interface 65, the scanner interface 66, the touch panel interface 67, the printer interface 68, the change machine interface 69, the settlement terminal interface 70, and the input device interface 71 are connected by a bus 72.

In the settlement device 3, the processor 61 and the other units are connected by the bus 72 to configure a computer. In the settlement device 3, the keyboard 31 and the first touch panel 32 are connected to the computer via the bus 72.

The processor 61 controls the other units of the settlement device 3 in order to implement various functions of the settlement device 3 according to an operating system or application programs. The processor 61 is, for example, a CPU (Central Processing Unit). The processor 61 is a multicore processor including a plurality of processor cores and is capable of executing a plurality of kinds of processing in parallel.

The main memory 62 includes a nonvolatile memory region and a volatile memory region. The main memory 62 stores the operating system or the application programs in the nonvolatile memory region. The main memory 62 also stores, in the nonvolatile or volatile memory region, data necessary for the processor 61 to execute processing for controlling the other units of the settlement device 3. The main memory 62 uses the volatile memory region as a work area where data is rewritten as appropriate by the processor 61. The nonvolatile memory region is, for example, a ROM (Read Only Memory). The volatile memory region is, for example, a RAM (Random Access Memory).

The auxiliary storage device 63 is, for example, an EEPROM (Electric Erasable Programmable Read-Only Memory), an HDD (Hard Disk Drive), an SSD (Solid State Drive), or the like. The auxiliary storage device 63 stores data used by the processor 61 in performing various kinds of processing, data created by the processing, and the like. The auxiliary storage device 63 sometimes stores the application programs described above.

The system clock 64 measures a date and time. The processor 61 operates based on the date and the time measured by the system clock 64.

The communication interface 65 is an interface for performing data communication with a store server via a communication network. The store server is a computer including a commodity master that stores commodity data such as commodity names and unit prices of commodities sold in a store, and the store server collects sales data of commodities processed by the settlement device 3 and manages sales, stocks, and the like of the entire store.

All of the scanner interface 66, the touch panel interface 67, the printer interface 68, the change machine interface 69, and the settlement terminal interface 70 are interfaces for performing data communication with the devices externally attached to the device main body 30. That is, the scanner interface 66 performs the data communication with the handy scanner 33. The touch panel interface 67 performs the data communication with the second touch panel 34. The printer interface 68 performs the data communication with the printer 35. The change machine interface 69 performs the data communication with the automatic change machine 36. The settlement terminal interface 70 performs the data communication with the cashless settlement terminal 37.

The input device interface 71 is an interface for performing the data communication with the input device 2 connected by the transmission cable 6. That is, the input device interface 71 performs the data communication with the stationary scanner 21, the handy scanner 22, the touch panel 23, the keyboard 24, and the display 25.

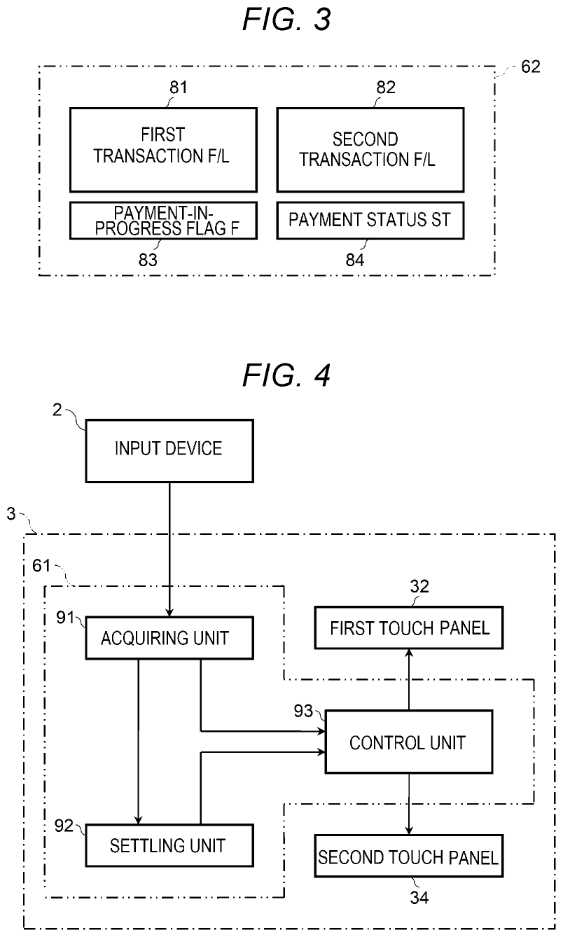

FIG. 3 is a schematic diagram illustrating aspects of a main memory 62. In the settlement device 3, the volatile storage region in the main memory 62 includes a first transaction file 81, a second transaction file 82, a flag memory 83, and a status memory 84. Both of the first transaction file 81 and the second transaction file 82 are regions for storing sales data of purchase commodities to be processed as one transaction. The sales data includes items such as commodity codes, commodity names, unit prices, purchase quantities, and sales prices of the purchase commodities. The sales prices are prices obtained by multiplying the unit prices by the purchase quantities. The first transaction file 81 stores the sales data relating to the purchase commodities from a start until an end of input of the commodity codes and the like of the purchase commodities to be processed as one transaction. The second transaction file 82 stores the sales data from the end of the input of the commodity codes and the like of the purchase commodities until the transaction is settled. Specifically, the first transaction file 81 and the second transaction file 82 store information input by the stationary scanner 21, the handy scanner 22, the touch panel 23, or the keyboard 24 of the input device 2, for example, information concerning a commodity code, a purchase quantity, and a price-cut amount of a purchase commodity to be purchased by the customer, or information input by the keyboard 31 or the first touch panel 32 of the settlement device 3, for example, information such as a commodity code, a purchase quantity, and a price-cut amount relating to a purchase commodity to be purchased by the customer.

The flag memory 83 is a region for storing a payment-in-progress flag F. The payment-in-progress flag F is one-bit data for identifying whether a price is being paid via the settlement device 3. In this embodiment, the payment-in-progress flag F indicating that the price is being paid is represented as “1” and the payment-in-progress flag F indicating that the price is not being paid is represented as “0”.

The status memory 84 is a region for storing a payment status ST. The payment status ST represents a payment mode. As payment modes, there are a self-mode and a support mode. The self-mode is a mode in which the customer performs a price payment operation by himself or herself. The support mode is a mode in which the store clerk intervenes in the price payment operation. In this embodiment, the payment status ST representing the self-mode is represented as “10” and the payment status ST representing the support mode is represented as “20”. The payment status ST before the price payment operation is started is represented as “00”.

### Explanation of Functions of the Settlement Device

FIG. 4 is a block diagram illustrating functional aspects of the processor 61 of the settlement device 3. As illustrated in FIG. 4, the processor 61 includes functions of an acquiring unit 91, a settling unit 92, and a control unit 93.

The acquiring unit 91 is a function for acquiring information relating to a transaction with the customer, such information being input by the store clerk using the input device 2. For example, a commodity code, a purchase quantity, and a price-cut amount are input to the acquiring unit 91 as information relating to a purchase commodity to be purchased by the customer.

The settling unit 92 is a function for settling a transaction with a payment provided by the customer. For example, if cash is deposited into the automatic change machine 36, the settling unit 92 recognizes that a payment amount by cash has been deposited and executes cash settlement processing. For example, if data of a credit card is read by the cashless settlement terminal 37, the settling unit 92 recognizes that a payment amount by the credit card has been deposited and executes credit card settlement processing. For example, if electronic money is read by the cashless settlement terminal 37, the settling unit 92 recognizes that a payment amount by electronic money has been deposited and executes electronic money settlement processing. For example, if a one-dimensional barcode or a two-dimensional code for code settlement is read by the cashless settlement terminal 37, the settling unit 92 recognizes that the balance specified by the one-dimensional barcode or the two-dimensional code has been deposited as a payment amount and executes code settlement processing. Since the settlement processing such as the cash settlement processing, the credit card settlement processing, the electronic money settlement processing, and the code settlement processing is well-known processing, detailed explanation of the settlement processing is omitted here.

The control unit 93 is a function for causing the first touch panel 32, which is the display unit for store clerks, to display information concerning the customer before settlement based on the information acquired by the acquiring unit 91. The control unit 93 is also a function for causing the second touch panel 34, which is the display unit for customers, to display an amount deposited by operation of the customer and for causing the first touch panel 32 not to display the amount. Specifically, the control unit 93 causes the first touch panel 32 and the second touch panel 34 to display a price necessary for settlement of a transaction with the customer before deposit by operation of the customer is performed, and causes the second touch panel 34 to display the deposited amount after the deposit is performed. If the amount deposited by the operation of the customer is less than the amount necessary for the settlement of the transaction, the control unit 93 causes the second touch panel 34 to display the difference between the amounts as the balance. If the amount deposited by the operation of the customer is equal to or greater than the amount necessary for the settlement of the transaction (sufficient for settling the transaction), the control unit 93 causes the second touch panel 34 to display the difference between the amounts as a change amount. When causing the second touch panel 34 to display a difference, the control unit 93 enables operation of a button programmed to return the display of the second touch panel 34 to a state from before the deposit was made. When causing the second touch panel 34 to display a change amount, the control unit 93 disables the operation of the button for returning the display of the second touch panel 34 to the prior state.

Using the functions explained above, the processor 61 of the settlement device 3 operates as explained below. That is, if acquiring information concerning a transaction with the customer from the input device 2, the processor 61 causes the first touch panel 32, which is the display unit for store clerks, to display information concerning the customer before settlement based on the information. If money is deposited by operation of the customer, the processor 61 causes the second touch panel 34 to display the deposited amount. The processor 61 settles the transaction with the deposited amount. The deposited amount is not displayed on the first touch panel 32. Therefore, the information concerning the customer before the settlement is not obstructed by the information concerning the deposited amount.

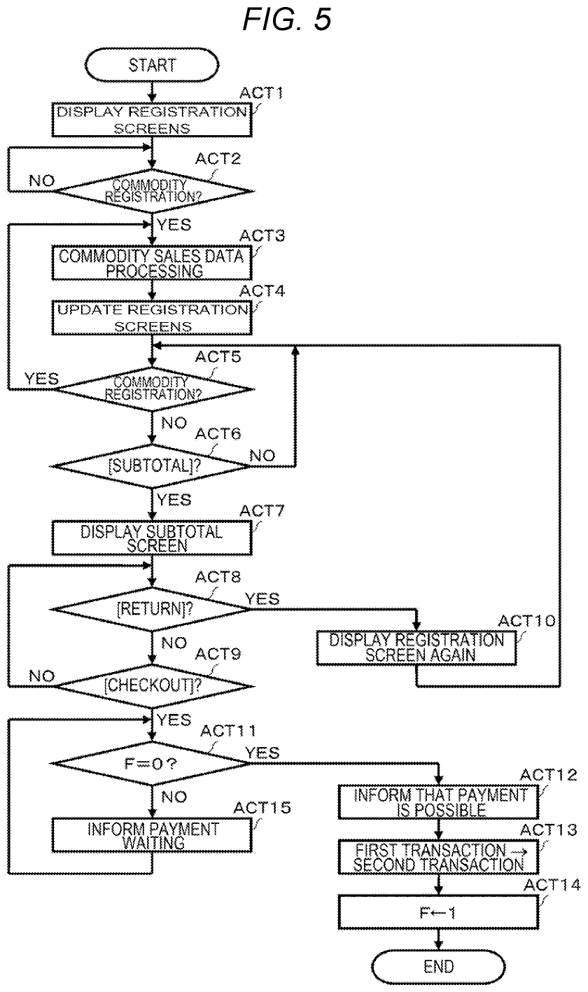

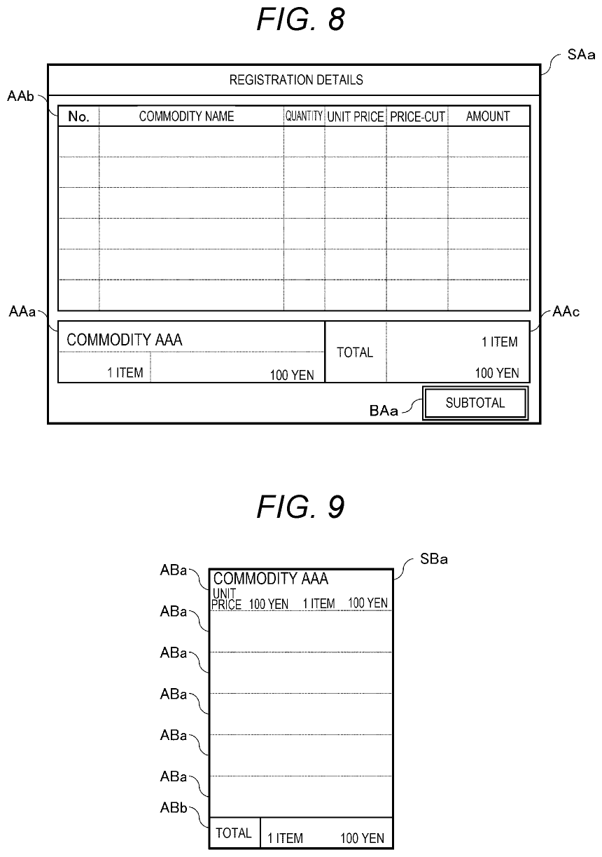

The functions of the acquiring unit 91, the settling unit 92, and the control unit 93 explained above are implemented by information processing executed by the processor 61 according to a job program (software). Procedures of information processing of an embodiment are explained with reference to flowcharts of FIGS. 5 to 7 and screen examples are depicted by FIGS. 8 to 25. Note that the specific procedures explained below are examples. The procedures can be changed as appropriate so long as the same effects or outcomes can be achieved. The screen examples are non-limiting. Content of text to be displayed, arrangement of images, types and layouts of software buttons, and the like can be varied as appropriate.

The job program is one of the application programs stored in the main memory 62 or the auxiliary storage device 63. The embodiment is not limited to a particular method of installing the job program in the main memory 62 or the auxiliary storage device 63. The job program can be recorded in a removable recording medium or distributed by communication via a network to be installed in the main memory 62 or the auxiliary storage device 63. Any recording medium may be used that is capable of storing a program and being read by a device like a CD-ROM, a memory card, or the like.

### Explanation of Information Processing of the Settlement Device

### First Information Processing

FIG. 5 is a flowchart illustrating first information processing executed by the processor 61 of the settlement device 3 according to the job program. The customer, who walks around a selling floor and collects purchase commodities, moves to a checkout place. The customer places the purchase commodities on the checkout counter 4 of the checkout lane PA when it is not occupied. If the customer comes to the checkout place, the store clerk standing in the space SP presses, for example, a start button of the touch panel 23. This operation is a command for inputting in the input device 2 to start. In other words, the operation is a command for the settlement device 3 to start registration of purchase commodities. In response to the command, the processor 61 starts the first information processing of the procedure illustrated in the flowchart of FIG. 5. In ACT 1, the processor 61 sets screens of the touch panel 23 and the display 25 in the input device 2 as registration screens.

FIG. 8 is an example of a registration screen SAa displayed on the touch panel 23. The registration screen SAa is divided into a current area AAa, a details area AAb, and a total area AAc. The current area AAa is an area for displaying a commodity name, a purchase quantity, and a sales price (amount) of the most recently inputted purchase commodity. The details area AAb is an area where commodity names, purchase quantities, unit prices, price-cut amounts, and sales amounts of purchase commodities in one transaction are displayed in a list format in order of a series of corresponding numbers. The total area AAc is an area where a total of the purchase quantities and a total of the sales prices of the purchase commodities for one transaction are displayed. The registration screen SAa includes a subtotal button BAa. The subtotal button BAa is a software button. The subtotal button BAa is a button programmed to request a subtotal to be output of purchase commodities registered by the settlement device 3 as one transaction.

FIG. 9 is an example of a registration screen SBa displayed on the display 25. In the registration screen SBa, a screen is divided into a plurality of rows (seven rows in the example illustrated in FIG. 9), the top row to the second row from the bottom being set as rows of a details area ABa, and the bottom row being set as a row of a total area ABb. In the rows of the details area ABa, commodity names, unit prices, purchase quantities, and sales prices of purchase commodities are displayed row by row. In the total area ABb, a total of the purchase quantities and a total of the purchase prices are displayed in one row.

The store clerk, who checks the registration screen SAa, inputs, to the input device 2, information concerning a purchase commodity placed on the checkout counter 4. That is, the store clerk scans, with the stationary scanner 21 or the handy scanner 22 of the input device 2, a barcode attached to the purchase commodity. The barcode is scanned, whereby a commodity code of the purchase commodity is input to the settlement device 3 via the input device interface 71. Note that, if a barcode is not attached to the purchase commodity, the store clerk causes the touch panel 23 of the input device 2 to display a list of commodities without barcodes. The store clerk selects the purchase commodity out of the list. The commodity code of the purchase commodity without a barcode is input to the settlement device 3 via the input device interface 71.

Referring back to FIG. 5, the processor 61, which set the screens of the touch panel 23 and the display 25 as the registration screen SAa and the registration screen SBa, respectively, proceeds to ACT 2. In ACT 2, the processor 61 waits for information necessary for registration of a purchase commodity to be input. Once the commodity code, which is information concerning the purchase commodity, is input from the input device 2 via the input device interface 71, the processor 61 determines that the information necessary for registration of the purchase commodity has been input, and the processor 61 proceeds from ACT 2 to ACT 3. In ACT 3, the processor 61 executes commodity sales data processing for the commodity specified by the input commodity code. This processing is processing for reading, from the commodity master, a commodity name, a unit price, and the like for the specified commodity, generating sales data of the purchase commodity including the commodity code, the commodity name, the unit price, a purchase quantity, and a sales amount for the specified commodity, and writing the sales data in the first transaction file 81, that is, registering the sales data.

The processor 61, after completing the commodity sales data processing, proceeds to ACT 4. In ACT 4, the processor 61 updates the registration screen SAa and the registration screen SBa.

Concerning the registration screen SAa, the processor 61 displays, in the current area AAa, the commodity name, the purchase quantity, and the sales amount of the sales data written in the first transaction file 81. At this time, if sales data of a purchase commodity, which was input immediately before the sales data was written, is displayed in the current area AAa, the processor 61 displays, in the details area AAb, a commodity name, a purchase quantity, a unit price, a price-cut amount, and a sales amount of the sales data. The processor 61 displays, in the total area AAc, totals of purchase quantities and sales amounts of all sales data stored in the first transaction file 81.

Concerning the registration screen SBa, the processor 61 displays, in a first (top) row of the details area ABa, the commodity name, the unit price, the purchase quantity, and the sales amount of the sales data written in the first transaction file 81. At this time, if sales data was already displayed in any rows of the details area ABa, the processor 61 sequentially shifts such sales data down and then displays, in the first row, the sales data written in the first transaction file 81. The processor 61 displays, in the total area ABb, totals of purchase quantities and sales prices of all sales data stored in the first transaction file 81.

The processor 61, after updating the registration screen SAa and the registration screen SBa, proceeds to ACT 5. In ACT 5, the processor 61 checks whether information concerning a next purchase commodity has been input to the input device 2. If information concerning a next purchase commodity has not been input, in ACT 6, the processor 61 checks whether the subtotal button BAa was pressed. If the subtotal button BAa was not pressed, the processor 61 returns to ACT 5. In other words, in ACT 5 and ACT 6, the processor 61 waits for information concerning a next purchase commodity to be input or for the subtotal button BAa to be pressed.

If information concerning a next purchase commodity is input in the waiting state in ACT 5 and ACT 6, the processor 61 returns to ACT 3. The processor 61 executes the processing in ACT 3 and ACT 4 in the same manner as explained above.

Therefore, the store clerk operates the stationary scanner 21, the handy scanner 22, or the touch panel 23 of the input device 2 and inputs information concerning purchase commodities placed on the checkout counter 4 item by item, whereby sales data of the purchase commodities for a transaction is stored in the first transaction file 81. The registration screen SAa and the registration screen SBa are updated accordingly. After completing the inputting of information concerning purchase commodities to the input device 2, the store clerk presses the subtotal button BAa.

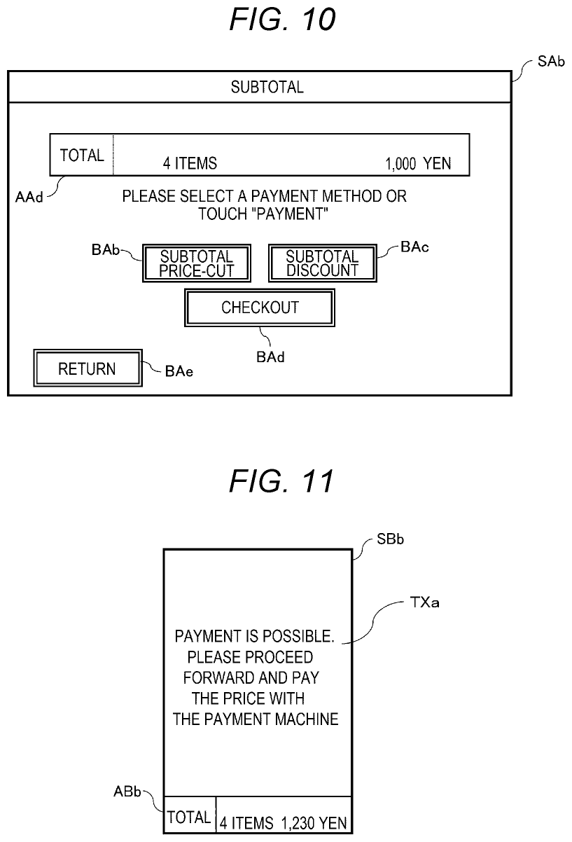

In the waiting state in ACT 5 and ACT 6, when the subtotal button BAa is pressed by the store clerk, the processor 61 proceeds to ACT 7. In ACT 7, the processor 61 sets a screen of the touch panel 23 in the input device 2 as a subtotal screen SAb (see FIG. 10).

FIG. 10 is an example of the subtotal screen SAb displayed on the touch panel 23. The subtotal screen SAb includes a total area AAd where a total of purchase quantities and a total of sales prices of purchase commodities in one transaction are displayed. The subtotal screen SAb includes a subtotal price-cut button BAb, a subtotal discount button BAc, a checkout button BAd, and a return button BAe. The buttons BAb, BAc, BAd, and BAe are software buttons. The subtotal price-cut button BAb is a button programmed to request a price-cut of a total amount. The subtotal discount button BAc is a button programmed to request a discount of a total price. The checkout button BAd is a button programmed to request to finish information input for purchase commodities. The return button BAe is a button programmed to request to return to the information input for purchase commodities.

The store clerk, after viewing the subtotal screen SAb, checks whether a purchase commodity for which information has not yet been input, remains on the checkout counter 4. If such a purchase commodity is present, the store clerk presses the return button BAe.

On the other hand, if no such purchase commodity is present, the store clerk checks whether a transaction is a subtotal price-cut target transaction or a subtotal discount target transaction. For example, if the customer presents a coupon for a subtotal price-cut, the transaction is a subtotal price-cut target transaction. The store clerk presses the subtotal price-cut button BAb and inputs a price-cut amount with a ten key pad of the keyboard 24. A total price is cut by the operation explained above. The processing explained above is referred to as subtotal price-cut processing. Similarly, for example, if the customer presents a coupon for a subtotal discount, the transaction is a subtotal discount target transaction. The store clerk presses the subtotal discount button BAc and inputs a discount rate with the ten key pad of the keyboard 24. The total price is discounted by the operation explained above. The processing explained above is referred to as subtotal discount processing.

After confirming that there is no purchase commodity for which information has not yet been input, and after confirming that a subtotal price-cut and a subtotal discount are each either inapplicable or already applied, the store clerk presses the checkout button BAd.

Referring back to FIG. 5, the processor 61, after setting the screen of the touch panel 23 as the subtotal screen SAb, proceeds to ACT 8. In ACT 8, the processor 61 checks whether the return button BAe was pressed. If the return button BAe was not pressed, the processor 61 proceeds to ACT 9. In ACT 9, the processor 61 checks whether the checkout button BAd was pressed. If the checkout button BAd was not pressed, the processor 61 returns to ACT 8. In other words, in ACT 8 and ACT 9, the processor 61, which has displayed the subtotal screen SAb, waits for the return button BAe to be pressed or for the checkout button BAd to be pressed.

Note that, if the subtotal price-cut button BAb or the subtotal discount button BAc is pressed in the waiting state in ACT 8 or ACT 9, the processor 61 performs the subtotal price-cut processing or the subtotal discount processing explained above. Thereafter, the processor 61 returns to the waiting state in ACT 8 and ACT 9.

If the return button BAe is pressed by the store clerk in the waiting state in ACT 8 and ACT 9, the processor 61 proceeds from ACT 8 to ACT 10. In ACT 10, the processor 61 returns the screen of the touch panel 23 to the immediately preceding registration screen SAa. The processor 61 returns to the waiting state in ACT 5 and ACT 6. Therefore, the store clerk only has to operate the stationary scanner 21, the handy scanner 22, or the touch panel 23 of the input device 2 and input the information concerning a purchase commodity that has not yet been input.

If the checkout button BAd is pressed by the store clerk in the waiting state in ACT 8 and ACT 9, the processor 61 proceeds from ACT 9 to ACT 11. In ACT 11, the processor 61 checks the payment-in-progress flag F. In a state in which a payment operation for a price has not yet been performed in the settlement device 3, the payment-in-progress flag F is set to “0”. If the payment-in-progress flag F is set to “0”, the processor 61 proceeds from ACT 11 to ACT 12. In ACT 12, the processor 61 sets the screen of the display 25 as a first notification screen SBb (see FIG. 11).

FIG. 11 is an example of the first notification screen SBb displayed on the display 25. The first notification screen SBb displays first text TXa together with information of the total area ABb in the registration screen SBa. The first text TXa is text including content for instructing the customer to move to a payment machine because the payment machine is ready to accept payment from that customer. The customer, after reading the first text TXa, moves toward the payment machine, that is, the settlement device 3, pays the price.

Referring back to FIG. 5, the processor 61, after displaying the first notification screen SBb on the display 25, proceeds to ACT 13. In ACT 13, the processor 61 copies data stored in the first transaction file 81, that is, sales data of purchase commodities registered as one transaction, to the second transaction file 82. In ACT 14, the processor 61 sets the payment-in-progress flag F of the flag memory 83 to “1”. Then, the processor 61 ends the first information processing relating to a transaction with a first customer.

The processor 61 then starts the first information processing relating to a transaction with a second (next) customer. That is, the processor 61 executes the processing in ACT 1 and subsequent acts in the same manner as explained above but for a second customer. At this time, it could occur that the payment-in-progress flag F set to “1” in ACT 14 of the first information processing for the first customer has not been subsequently reset to “0” at a point in time of ACT 11 of the first information processing for the second customer.

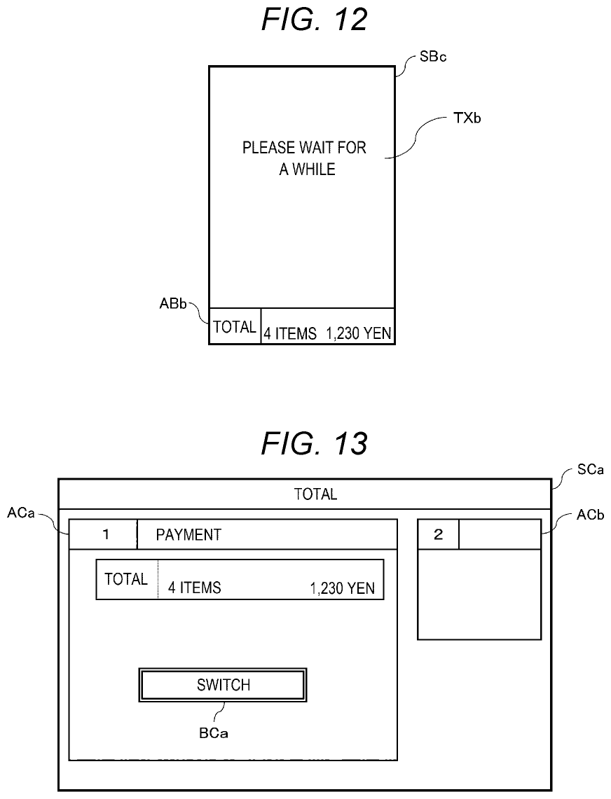

If the payment-in-progress flag F is still set to “1” in ACT 11, the processor 61 proceeds from ACT 11 to ACT 15. In ACT 15, the processor 61 sets the screen of the display 25 as a second notification screen SBc (see FIG. 12).

FIG. 12 is an example of the second notification screen SBc displayed on the display 25. The second notification screen SBc displays second text TXb together with information of the total area ABb in the registration screen SBa. The second text TXb is text including content for instructing a customer to wait because a payment machine is not ready to accept payment from that customer. In this case, the second customer, after reading the second text TXb, waits until payment of a price becomes possible.

Referring back to FIG. 5, the processor 61, after displaying the second notification screen SBc on the display 25, returns to ACT 11. In ACT 11, the processor 61 waits for the payment-in-progress flag F to be reset to “0”. The payment-in-progress flag F is reset to “0” once settlement processing has been completed in second information processing explained below. Once the payment-in-progress flag F is reset to “0”, the processor 61 proceeds from ACT 11 to ACT 12 for the second customer. The processor 61 executes the processing in ACT 12 to ACT 14 in the same manner as explained above for the first customer. That is, the processor 61 displays the first notification screen SBb on the display 25. According to this display, the second customer moves toward the settlement device 3 and pays a price.

The processor 61 copies data stored in the first transaction file 81 for the second customer to the second transaction file 82. The processor 61 sets the payment-in-progress flag F to “1” and ends the first information processing for the second customer. Thereafter, the processor 61 repeatedly executes the first information processing as explained above for a third customer, a fourth customer, and so on.

The processor 61 implements the function of the acquiring unit 91 by executing the functionality of ACT 2, ACT 3, ACT 5, ACT 6, ACT 8, and ACT 9 in cooperation with the input device interface 71.

### Second Information Processing

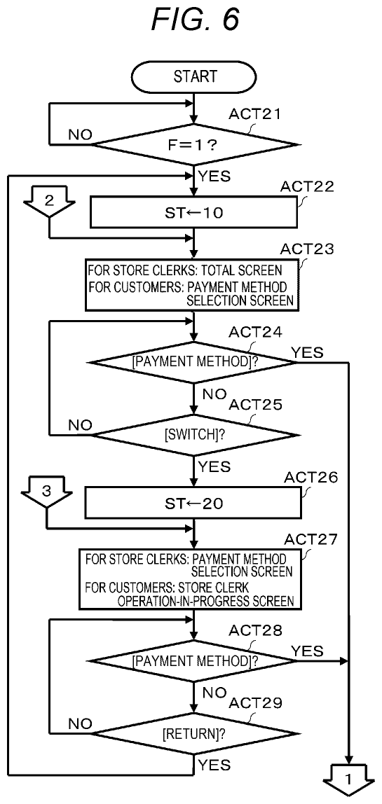

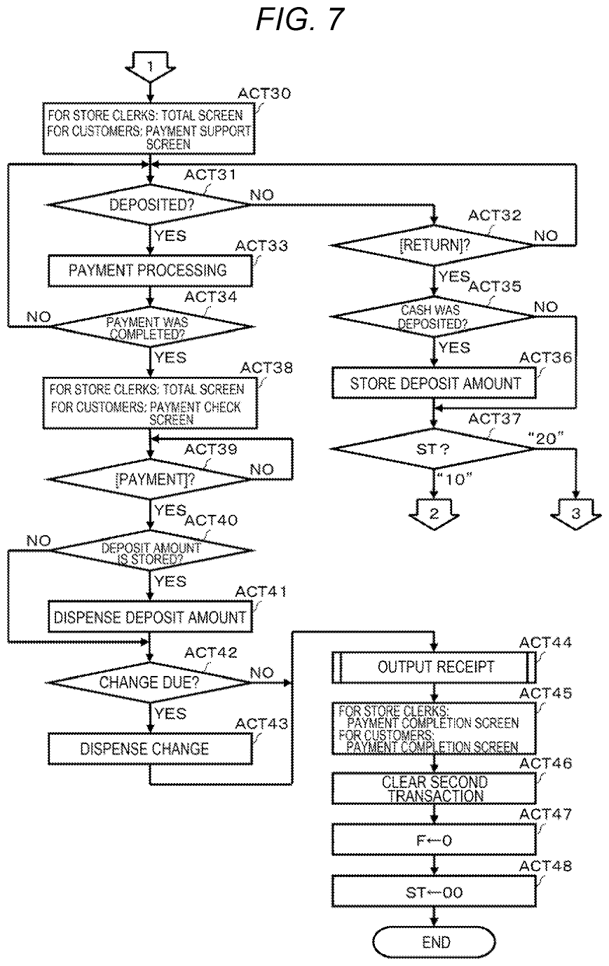

FIG. 6 and FIG. 7 are flowcharts illustrating second information processing executed by the processor 61 of the settlement device 3 according to the job program. The processor 61 executes the second information processing in parallel with the first information processing explained above.

In ACT 21, the processor 61 waits for the payment-in-progress flag F to be set to “1”. Note that, in this waiting state, initial screens are displayed on the first touch panel 32 and the second touch panel 34. Embodiments are not limited to particular contents for the initial screens. For example, the initial screen displayed on the first touch panel 32 may be a screen having the same layout as a layout of a total screen SCa explained below. However, no information is displayed on the initial screen displayed on the first touch panel 32. The initial screen displayed on the second touch panel 34 is a screen on which text such as “Welcome” or an image is displayed. Alternatively, the initial screen displayed on the second touch panel 34 may be blank.

Once the payment-in-progress flag F has been set to “1” in ACT 21 by the first information processing, the processor 61 proceeds from ACT 21 to ACT 22. In ACT 22, the processor 61 sets the payment status ST to “10”. In ACT 23, the processor 61 sets the screen of the first touch panel 32, which is the display unit for store clerks, as a total screen SCa (see FIG. 13) and sets the screen of the second touch panel 34, which is the display unit for customers, as a payment method selection screen SDa (see FIG. 15).

FIG. 13 is an example of the total screen SCa displayed on the first touch panel 32. The total screen SCa includes a first customer area ACa and a second customer area ACb side by side. The first customer area ACa is an area for displaying information concerning the first customer who is being prompted to pay a price. A total number of items and a total price for the transaction of the first customer are displayed in the first customer area ACa. That is, a total of purchase quantities and a total of sales prices calculated based on the sales data of the purchase commodities stored in the second transaction file 82 are displayed in the first customer area ACa. A switch button BCa is displayed in the first customer area ACa. The switch button BCa is a software button. The switch button BCa is a button programmed to enable the store clerk to intervene in a payment operation.

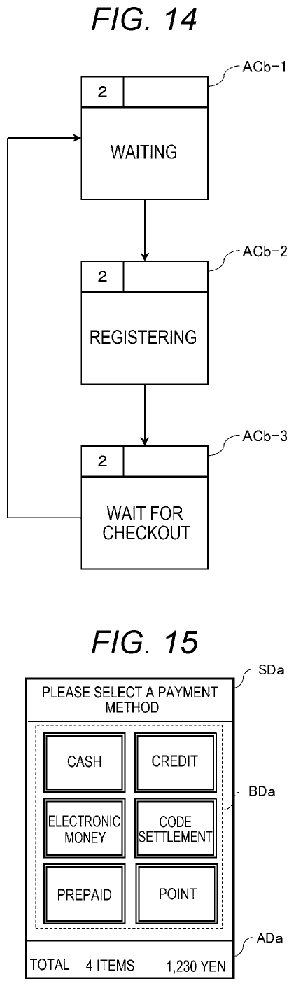

The second customer area ACb is an area for displaying information concerning the second customer. An example of the information displayed in the second customer area ACb is illustrated in FIG. 14. FIG. 14 is a schematic diagram illustrating a transition example of the information displayed in the second customer area ACb.

In a state in which no information for any commodity to be purchased by the second customer has yet been input to the input device 2, “waiting” is displayed, for example, as illustrated in a second customer area ACb-1. If at least some information has been input to the input device 2 for the second customer, “registering” is displayed, for example, as illustrated in a second customer area ACb-2. If information has been input to the input device 2 for all the purchase commodities of the second customer, “waiting for checkout” is displayed, for example, as illustrated in a second customer area ACb-3. Thereafter, if checkout for the first customer is completed and checkout begins for the second customer, the display returns to “waiting” as illustrated in the second customer area ACb-1. Note that the second customer area ACb-1 may be blank.

As explained above, the information displayed in the first customer area ACa of the total screen SCa is an area for displaying information concerning the first customer being prompted to pay. The information displayed in the second customer area ACb of the total screen SCa is an area for displaying information concerning the second customer who will be prompted to pay after the first customer whose information is displayed in the first customer area ACa. That is, the total screen SCa can be considered to be a screen for displaying information concerning a customer before settlement.

FIG. 15 is an example of a payment method selection screen SDa displayed on the second touch panel 34. The payment method selection screen SDa includes a payment method selection button group BDa. The payment method selection button group BDa includes a cash button, a credit button, an electronic money button, a code settlement button, a prepaid button, and a point button. All of the cash button, the credit button, the electronic money button, the code settlement button, the prepaid button, and the point button are software buttons.

The payment method selection screen SDa includes a total area ADa. A total number of items and a total price for a customer being prompted to pay are displayed in the total area ADa. That is, a total of purchase quantities and a total of sales prices calculated based on the sales data of the purchase commodities stored in the second transaction file 82 are displayed in the total area ADa.

The customer, upon viewing the payment method selection screen SDa, presses a button of a desired payment method out of the payment method selection button group BDa. For example, a customer desiring to pay by cash presses the cash button. A customer desiring to pay by a credit card presses the credit button. A customer desiring to pay by electronic money presses the electronic money button. A customer desiring to pay by code settlement presses the code settlement button. A customer desiring to pay by a prepaid card presses the prepaid button. A customer desiring to pay by points presses the point button.

Referring back to FIG. 6, the processor 61, after setting the screen of the first touch panel 32 as the total screen SCa and setting the screen of the second touch panel 34 as the payment method selection screen SDa, proceeds to ACT 24. In ACT 24, the processor 61 checks whether one button of the payment method selection button group BDa displayed on the payment method selection screen SDa has been pressed. If a button of the payment method selection button group BDa has not been pressed, the processor 61 proceeds to ACT 25. In ACT 25, the processor 61 checks whether the switch button BCa displayed on the total screen SCa has been pressed. If the switch button BCa of the total screen SCa has not been pressed either, the processor 61 returns to ACT 24. As explained above, in ACT 24 and ACT 25, the processor 61 waits for a button of the payment method selection button group BDa in the payment method selection screen SDa to be pressed or for the switch button BCa of the total screen SCa to be pressed.

If a button of the payment method selection button group BDa is pressed by the customer in the waiting state in ACT 24 and ACT 25, the processor 61 proceeds from ACT 24 to ACT 30 in FIG. 7.

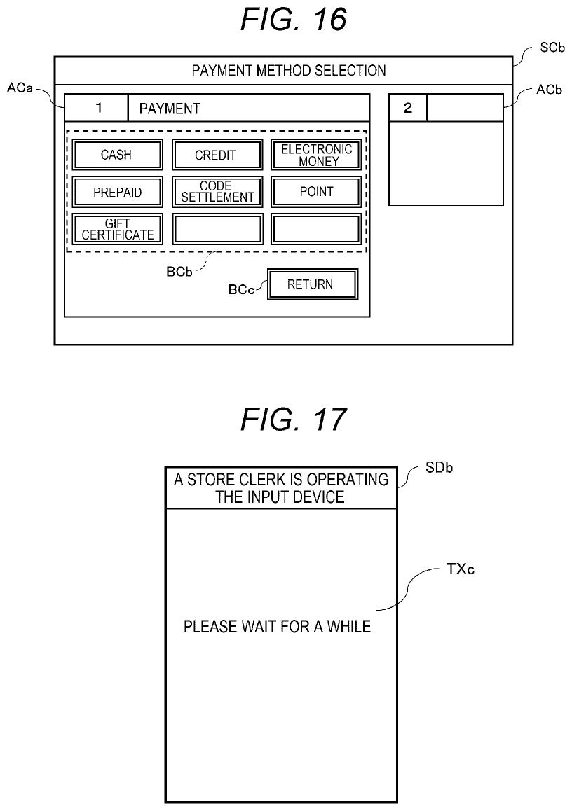

On the other hand, if the switch button BCa is pressed by the store clerk in the waiting state in ACT 24 and ACT 25, the processor 61 proceeds from ACT 25 to ACT 26. In ACT 26, the processor 61 sets the payment status ST to “20”. In ACT 27, the processor 61 sets the screen of the first touch panel 32, which is the display unit for store clerks, as a payment method selection screen SCb (see FIG. 16) and sets the screen of the second touch panel 34, which is the display unit for customers, as a store clerk operation-in-progress screen SDb (see FIG. 17).

FIG. 16 is an example of the payment method selection screen SCb displayed on the first touch panel 32. In the payment method selection screen SCb, a payment method selection button group BCb and a return button BCc are disposed in the first customer area ACa of the total screen SCb. The second customer area ACb of the total screen SCb is displayed in the same manner as on the payment method selection screen SCa.

The payment method selection button group BCb includes a gift certificate button in addition to the cash button, the credit button, the electronic money button, the code settlement button, the prepaid button, and the point button explained above. The gift certificate button is also a software button. If a price is paid by a gift certificate, the store clerk generally needs to intervene in order to check the validity of the gift certificate. Therefore, the gift certificate button is not included in the payment method selection screen SDa of the second touch panel 34 (operated by the customer). However, the gift certificate button is included in the payment method selection screen SCb of the first touch panel 32 (operated by the store clerk). The return button BCc is a software button. The return button BCc is a button programmed to return the payment method selection screen SCb to the immediately preceding screen, that is, the total screen SCa.

FIG. 17 is an example of the store clerk operation-in-progress screen SDb displayed on the second touch panel 34. As illustrated in FIG. 17, third text TXc for notifying the customer that the store clerk is in operation is displayed on the store clerk operation-in-progress screen SDb. Note that an image indicating that the store clerk is in operation may be displayed instead of the third text TXc. Alternatively, the third text TXc and the image may be displayed together. In short, the display of the store clerk operation-in-progress screen SDb is sufficient as long as the customer is effectively notified that the store clerk is in operation.

Referring back to FIG. 6, the processor 61, which set the screen of the first touch panel 32 as the payment method selection screen SCb and set the screen of the second touch panel 34 as the store clerk operation-in-progress screen SDb, proceeds to ACT 28. In ACT 28, the processor 61 checks whether one button of the payment method selection button group BCb displayed on the payment method selection screen SCb has been pressed. If a button of the payment method selection button group BCb has not been pressed, the processor 61 proceeds to ACT 29. In ACT 29, the processor 61 checks whether the return button BCc of the payment method selection screen SCb has been pressed. If the return button BCc has not been pressed either, the processor 61 returns to ACT 28. As explained above, in ACT 28 and ACT 29, the processor 61 waits for a button of the payment method selection button group BCb to be pressed or the return button BCc to be pressed.

If a button of the payment method selection button group BCb is pressed by the store clerk in the waiting state in ACT 28 and ACT 29, the processor 61 proceeds from ACT 28 to ACT 30 in FIG. 7. Processing in ACT 30 and in subsequent acts is explained below.

In contrast, if the return button BCc is pressed by the store clerk in the waiting state in ACT 28 and ACT 29, the processor 61 returns from ACT 29 to ACT 22. That is, the processor 61 sets the payment status ST to “10”. The processor 61 sets the screen of the first touch panel 32 as the total screen SCa and sets the screen of the second touch panel 34 as the payment method selection screen SDa. The processor 61 waits for a button of the payment method selection button group BDa on the payment method selection screen SDa to be pressed or the switch button BCa of the total screen SCa to be pressed.

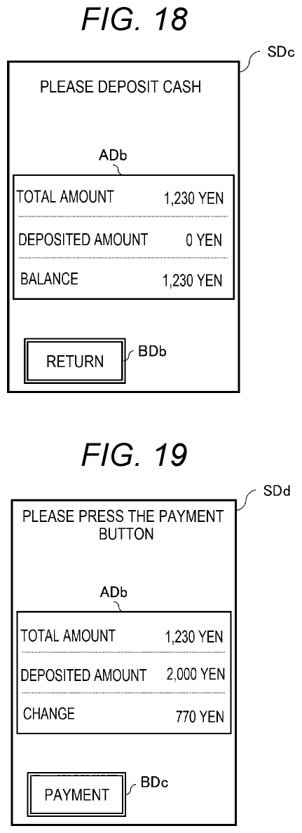

If a button of the payment method selection button group BDa displayed on the second touch panel 34 is pressed by the customer in ACT 24 or a button of the payment method selection button group BCb displayed on the first touch panel 32 is pressed by the store clerk in ACT 28 as explained above, the processor 61 proceeds to ACT 30 in FIG. 7. In ACT 30, the processor 61 sets the screen of the first touch panel 32, which is the display unit for store clerks, as the total screen SCa (see FIG. 13) and sets the screen of the second touch panel 34, which is the display unit for customers, as a payment support screen SDc (see FIG. 18).

FIG. 18 is an example of the payment support screen SDc displayed on the second touch panel 34. FIG. 18 illustrates the payment support screen SDc displayed if the cash button of the payment method selection button group BDa or the payment method selection button group BCb is pressed. The payment support screen SDc includes a change machine information area ADb. A return button BDb is disposed on the payment support screen SDc.

A total amount (price), a deposited amount, that is, an amount of cash deposited to the automatic change machine 36, and the balance obtained by subtracting the deposited amount from the total amount are displayed in the change machine information area ADb. The return button BDb is a software button. The return button BDb is a button programmed to suspend payment by a selected payment method and return the display to a state before the payment method selection.

Referring back to FIG. 7, the processor 61, after setting the screen of the first touch panel 32 as the total screen SCa and setting the screen of the second touch panel 34 as the payment support screen SDc, proceeds to ACT 31. In ACT 31, the processor 61 checks whether money has been deposited. If the money has not been deposited, the processor 61 proceeds to ACT 32. In ACT 32, the processor 61 checks whether the return button BDb has been pressed. If the return button BDb has not been pressed, the processor 61 returns to ACT 31. As explained above, in ACT 31 and ACT 32, the processor 61 waits for money to be deposited or for the return button BDb to be pressed.

A customer who has selected the cash payment as the price payment method, deposits cash to the automatic change machine 36. A customer who has selected the credit card payment, causes a reader of the cashless settlement terminal 37 to read data of a credit card. A customer who has selected the electronic money payment, causes the reader of the cashless settlement terminal 37 to read data of an electronic money medium. A customer who has selected the code settlement payment, causes a scanner of the cashless settlement terminal 37 to read a one-dimensional barcode or a two-dimensional data code for code settlement. A customer desiring the prepaid card payment causes the reader of the cashless settlement terminal 37 to read data of a prepaid card. A customer desiring the point payment causes the reader of the cashless settlement terminal 37 to read data of a point card. If the payment operation by the customer explained above has been performed, in ACT 31, the processor 61 determines that the price has been deposited.

The processor 61, after determining that the price has been deposited, proceeds from ACT 31 to ACT 33. In ACT 33, the processor 61 executes payment processing. For example, if the cash payment was selected, the processor 61 deducts an amount of cash deposited to the automatic change machine 36 from the total amount. If the credit card payment was selected, the processor 61 authenticates a credit card. If the electronic money payment was selected, the processor 61 deducts the total price from the balance of electronic money. If the code settlement payment was selected, the processor 61 deducts the total price from the balance of code settlement. If the prepaid card payment was selected, the processor 61 deducts the total price from the balance of a prepaid card. If the point payment was selected, the processor 61 deducts the total price from an amount equivalent to a cumulative point.

The processor 61, after executing the payment processing, proceeds to ACT 34. In ACT 34, the processor 61 determines whether the payment was completed. For example, if the amount of the cash deposited to the automatic change machine 36 was insufficient for covering the total price, the processor 61 determines that the payment is incomplete. Similarly, if failing in authenticating the credit card or if the balance of the electronic money, the code settlement, the prepaid card, the cumulative point, or the like is insufficient for covering the total price, the processor 61 determines that the payment is incomplete. If the payment is incomplete, the processor 61 returns to ACT 31. In ACT 31 and ACT 32, the processor 61 waits for payment to be made again or the return button BDb to be pressed.

In a state in which the payment is incomplete, that is, in the waiting state in ACT 31 and ACT 32, the customer can change the payment method to another method. For example, if the cash payment was previously selected but the customer's cash on hand is insufficient, the customer can change the payment method to a payment method other than the cash. The customer desiring to change the payment method to another payment method presses the return button BDb.

If the return button BDb is pressed by the customer in the waiting state in ACT 31 and ACT 32, the processor 61 proceeds from ACT 32 to ACT 35. In ACT 35, the processor 61 checks whether the return button BDb was pressed after some cash was already deposited to the automatic change machine 36. If the return button BDb is pressed after some cash was deposited to the automatic change machine 36, the processor 61 proceeds to ACT 36. In ACT 36, the processor 61 stores the amount of the cash already deposited to the automatic change machine 36, a so-called “deposit amount” in the main memory 62. If no cash was previously deposited to the automatic change machine 36 and the return button BDb was pressed, the processor 61 skips the processing in ACT 36.

After executing or skipping the processing in ACT 36, the processor 61 proceeds to ACT 37. In ACT 37, the processor 61 checks the status ST. Note that, at this point in time, the status ST is “10” or “20”.

If the status ST is “10”, the processor 61 returns to ACT 23 in FIG. 6. That is, the processor 61 sets the screen of the first touch panel 32, which is the display unit for store clerks, as the total screen SCa (see FIG. 13) and sets the screen of the second touch panel 34, which is the display unit for customers, as the payment method selection screen SDa (see FIG. 15). As explained above, if the customer presses the return button BDb when the status ST is “10”, the payment method selection screen SDa is displayed on the second touch panel 34. Therefore, the customer only has to press a button of a desired payment method out of the payment method selection button group BDa again.

Returning to ACT 37 of FIG. 7, in contrast, if the status ST is “20”, the processor 61 returns to ACT 27 in FIG. 6. That is, the processor 61 sets the screen of the first touch panel 32, which is the display unit for store clerks, as the payment method selection screen SCb (see FIG. 16) and sets the screen of the second touch panel 34, which is the display unit for customers, as the store clerk operation-in-progress screen SDb (see FIG. 17). As explained above, if the customer presses the return button BDb when the status ST is “20”, the payment method selection screen SCb is displayed on the first touch panel 32. Therefore, the store clerk only has to press the button of the payment method desired by the customer out of the payment method selection button group BCb again.

Returning to ACT 34 of FIG. 7, the processor 61, after recognizing that the payment has been completed, proceeds to ACT 38. In ACT 38, the processor 61 sets the screen of the first touch panel 32, which is the display unit for store clerks, as the total screen SCa (see FIG. 13) and sets the screen of the second touch panel 34, which is the display unit for customers, as a payment check screen SDd (see FIG. 19).

FIG. 19 is an example of the payment check screen SDd displayed on the second touch panel 34. FIG. 19 illustrates the payment check screen SDd displayed if the cash button of the payment method selection button group BDa or the payment method selection button group BCb is pressed. The payment check screen SDd includes the change machine information area ADb. In the change machine information area ADb, a difference obtained by subtracting the deposited amount from the total price is displayed as the balance on the payment support screen SDc but a difference obtained by subtracting the total price from the deposited amount is displayed as a change amount on the payment check screen SDd. A payment button BDc is disposed on the payment check screen SDd. The return button BDb disposed on the payment support screen SDc is not disposed on the payment check screen SDd. The payment button BDc is a button programmed to confirm that the payment has been completed. The customer, after having finished the payment of the total price, presses the payment button BDc.

Referring back to FIG. 7, the processor 61, after setting the screen of the first touch panel 32 as the total screen SCa and setting the screen of the second touch panel 34 as the payment check screen SDd, proceeds to ACT 39. In ACT 39, the processor 61 waits for the payment button BDc to be pressed. After the payment button BDc has been pressed by the customer, the processor 61 proceeds to ACT 40. In ACT 40, the processor 61 checks whether a deposit amount has been stored. If a deposit amount was stored in the processing in ACT 36, the processor 61 proceeds to ACT 41. In ACT 41, the processor 61 controls the automatic change machine 36 such that a cash equivalent to the deposited amount is dispensed. If a deposit amount was not stored in the processing in ACT 36, the processor 61 skips the processing in ACT 41.

After executing or skipping the processing in ACT 41, the processor 61 proceeds to ACT 42. In ACT 42, the processor 61 checks whether change is owed to the customer. If change is owed because the cash payment was selected as the payment method and cash of an amount exceeding the total price was deposited to the automatic change machine 36, the processor 61 proceeds to ACT 43. In ACT 43, the processor 61 controls the automatic change machine 36 such that a cash equivalent to a change amount is dispensed. If change is not owed, the processor 61 skips the processing in ACT 43.

After executing or skipping the processing in ACT 43, the processor 61 proceeds to ACT 44. In ACT 44, the processor 61 controls output of a receipt. That is, the processor 61 generates receipt data indicating details of a commercial transaction based on the sales data and the like stored in the second transaction file 82. The processor 61 outputs the receipt data to the printer 35. Consequently, the printer 35 operates and prints and dispenses a paper receipt. Note that, if an electronic receipt ID was input in the input device 2, the processor 61 transmits the receipt data to an electronic receipt server together with the electronic receipt ID. Thereafter, the customer receives a receipt in a form of an electronic receipt by operating a smartphone.

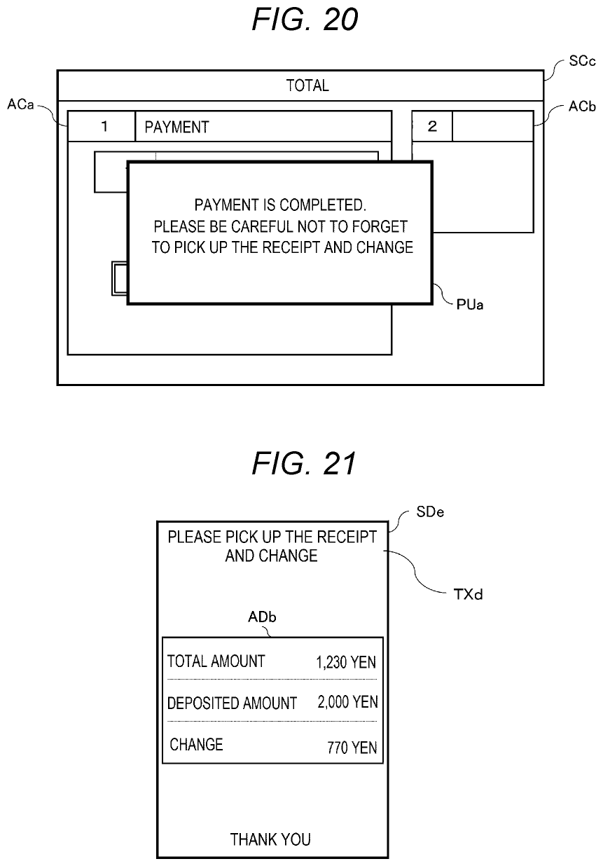

The processor 61 after outputting the receipt, proceeds to ACT 45. In ACT 45, the processor 61 sets the screen of the first touch panel 32, which is the display unit for store clerks, as a payment completion screen SCc (see FIG. 20) and sets the screen of the second touch panel 34, which is the display unit for customers, as a payment completion screen SDe (see FIG. 21).

FIG. 20 is an example of the payment completion screen SCc displayed on the first touch panel 32. In the payment completion screen SCc, a pop-up window PUa for notifying the store clerk that payment was completed is displayed over the total screen SCa. Since the pop-up window PUa is displayed, the store clerk recognizes that payment of the customer has been completed in the settlement device 3.

FIG. 21 is an example of the payment completion screen SDe displayed on the second touch panel 34. FIG. 21 illustrates the payment completion screen SDe displayed if the cash button of the payment method selection button group BDa or the payment method selection button group BCb is pressed. The payment completion screen SDe displays, together with the change machine information area ADb, fourth text TXd for informing the customer not to forget to pick up the receipt and the change. Note that, if the receipt is dispensed as the electronic receipt, the fourth text TXd is changed to, for example: “Please pick up the change. Please check the electronic receipt”. If a paper receipt is dispensed from the printer 35, the customer, after reading the content displayed on the payment completion screen SDe, picks up the paper receipt. If cash such as the deposit amount or the change has been dispensed from the automatic change machine 36, the customer picks up the cash.

Referring back to FIG. 7, the processor 61, after setting the screen of the first touch panel 32 as the payment completion screen SCc and setting the screen of the second touch panel 34 as the payment completion screen SDe, proceeds to ACT 46. In ACT 46, the processor 61 clears (erases) the second transaction file 82. In ACT 47, the processor 61 resets the payment-in-progress flag F to “0”. Further, in ACT 48, the processor 61 sets the payment status ST to “00”. Then, the processor 61 ends the second information processing. Consequently, price payment of the first customer has finished being processed in the settlement device 3. Each time the payment-in-progress flag F is set to “1” in ACT 14 in FIG. 5, the processor 61 again executes the second information processing explained above. Consequently, price payment of the second customer is processed in the settlement device 3. Thereafter, price payment of a third customer, a fourth customer, and the like is processed in order in the settlement device 3.

In FIGS. 18 and 19, the payment support screen SDc and the payment check screen SDd displayed if the cash button is pressed are illustrated. That is, the payment support screen SDc is a screen having content of displaying an amount of cash deposited to the automatic change machine 36 together with a total amount and the balance. The payment check screen SDd is a screen having content of displaying a deposited amount, a change amount after the end of a payment of a price by cash, and the total price. The contents displayed by the payment support screen and the payment check screen vary depending on a payment method.

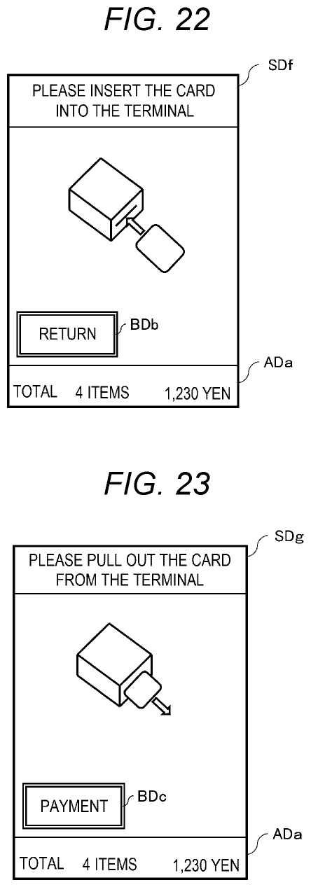

FIGS. 22 and 23 illustrate examples of a payment support screen SDf and a payment check screen SDg displayed if the credit button is pressed. The payment support screen SDf displays, together with the return button BDb, an operation method of a customer for causing the cashless settlement terminal 37 to read data of a credit card. The payment check screen SDg displays, together with the payment button BDc, an operation method of the customer after credit card settlement is finished.

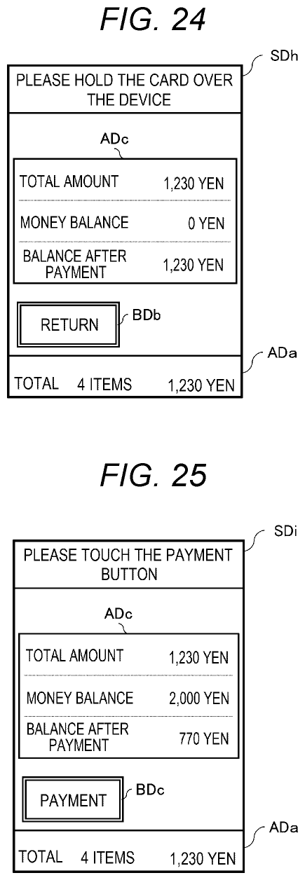

FIGS. 24 and 25 illustrate examples of a payment support screen SDh and a payment check screen SDi displayed if the electronic money button is pressed. The payment support screen SDh and the payment check screen SDi each include an electronic money information area ADc. The electronic money information area ADc is an area for displaying a total price, an electronic money balance, and a balance after payment. On the payment support screen SDh, since data of electronic money is not read, the electronic money balance is “0” and the balance after payment is the total price. On the payment check screen SDi, the electronic money balance is the balance before price payment and the balance after payment is the balance after the price payment. Note that the payment support screen SDh and the payment check screen SDi are the same as the other screens with respect to the return button BCb being displayed on the payment support screen SDh and the payment button BDc being displayed on the payment check screen SDi.

The processor 61 implements the function of the settling unit 92 by executing the operations of ACT 31, ACT 33, ACT 34, ACT 39, and ACT 44 of FIG. 7. The processor 61 implements the function of the control unit 93 by executing the operations of ACT 23 of FIG. 6 and ACT 30 and ACT 38 of FIG. 7.

### Explanation of Action Effects of the Settlement Device

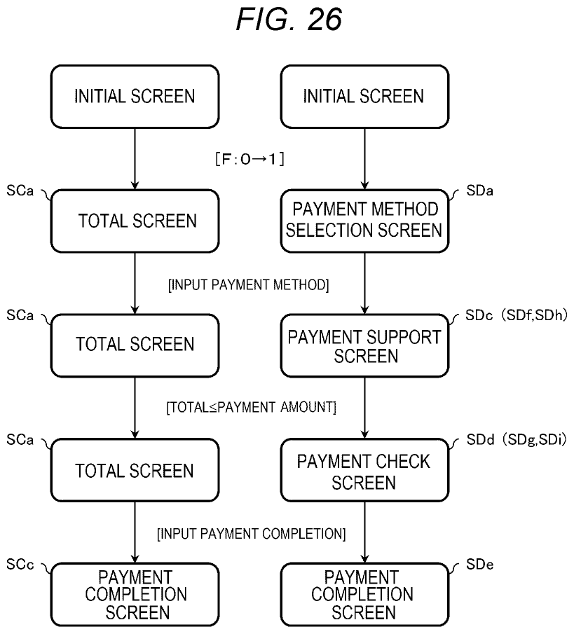

FIG. 26 illustrates the transitions of screens respectively displayed on the first touch panel 32 and the second touch panel 34 as the customer completely performs the payment operation for a price by himself or herself. The transition of the screens illustrated in FIG. 26 is executed by the processor 61 controlling the first touch panel 32 and the second touch panel 34.

First, in a situation in which the payment-in-progress flag F is “0”, that is, the settlement processing is not being performed in the settlement device 3, initial screens are respectively displayed on the first touch panel 32 and the second touch panel 34.

If the checkout button BAd of the subtotal screen SAb displayed on the touch panel 23 of the input device 2 is pressed by the store clerk, the payment-in-progress flag F is set to “1”. At this time, the screen of the first touch panel 32 transitions from the initial screen thereof to the total screen SCa. The screen of the second touch panel 34 transitions from the initial screen thereof to the payment method selection screen SDa. Thereafter, the customer upon moving to the side of the settlement device 3 finds a button of a desired payment method out of the payment method selection button group BDa displayed on the payment method selection screen SDa. The customer presses the button.

After the button of the payment method selection button group BDa is pressed, the screen of the second touch panel 34 transitions from the payment method selection screen SDa to the payment support screen SDc (or one of SDf and SDh). The screen of the first touch panel 32 does not transition from the total screen SCa. The customer after viewing the payment support screen SDc (or one of SDf and SDh) performs a payment operation for a price with the selected payment method according to content displayed on the screen SDc (or one of SDf and SDh). For example, if the cash payment was selected, the customer deposits cash to the automatic change machine 36.

After the payment of the price has been completed, the screen of the second touch panel 34 transitions from the payment support screen SDc (or one of SDf and SDh) to the payment check screen SDd (or one of SDg and SDi). The screen of the first touch panel 32 does not transition from the total screen SCa. The customer after viewing the payment check screen SDd (or one of SDg and SDi) presses the payment button BDc of the screen SDd (or one of SDg and SDi). However, if the screen of the first touch panel 32 has not transitioned from the total screen SCa, the store clerk can recognize that the customer is still paying. If another customer is present, the store clerk performs, on the input device 2, an information input operation for commodities to be purchased by the next customer.

After the payment button BDc has been pressed by the customer who is currently paying, the screen of the second touch panel 34 transitions from the payment check screen SDd (or one of SDg and SDi) to the payment completion screen SDe. The screen of the first touch panel 32 also transitions from the total screen SCa to the payment completion screen SCc. The store clerk, after viewing the payment completion screen SCc, recognizes that the customer has finished paying.

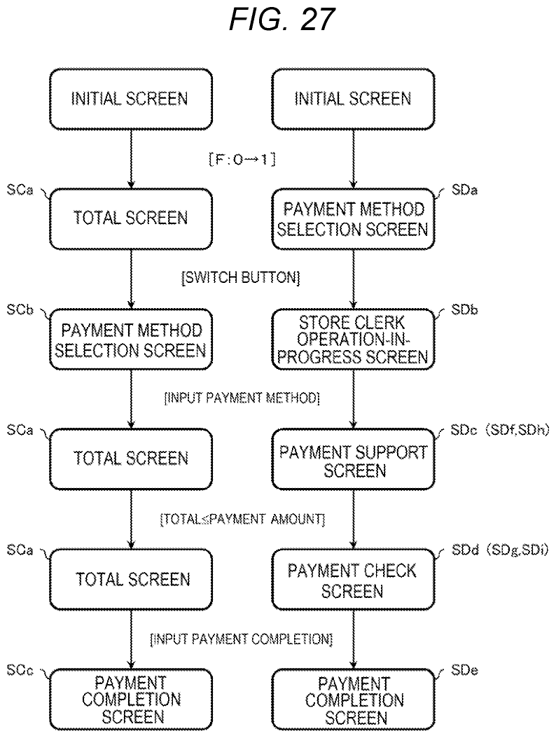

FIG. 27 is a diagram for explaining the screen transitions of the first touch panel 32 and the second touch panel 34 in the case in which the store clerk selects a price payment method in place of the customer. The transition of the screens illustrated in FIG. 27 is also executed by the processor 61 controlling the first touch panel 32 and the second touch panel 34.

The screen transitions are the same as the screen transitions illustrated in FIG. 26 until after the screen of the first touch panel 32 transitions from the initial screen thereof to the total screen SCa and the screen of the second touch panel 34 transitions from the initial screen thereof to the payment method selection screen SDa.

For example, if the customer has taken considerable time in operation of the payment method selection screen SDa, the store clerk may press the switch button BCa of the total screen SCa. Then, the screen of the first touch panel 32 transitions from the total screen SCa to the payment method selection screen SCb. The screen of the second touch panel 34 transitions from the payment method selection screen SDa to the store clerk operation-in-progress screen SDb. The store clerk asks the customer for a desired payment method. The store clerk presses a button of the payment method designated by the customer out of the payment method selection button group BCb displayed on the payment method selection screen SCb.

After the store clerk has pressed the button of the payment method, the screen of the first touch panel 32 transitions from the payment method selection screen SCb to the total screen SCa. The screen of the second touch panel 34 transitions from the store clerk operation-in-progress screen SDb to the payment support screen SDc (or one of SDf and SDh). Thereafter, the customer performs a payment operation for a price with a desired payment method according to content displayed on the payment support screen SDc (or one of SDf and SDh). Thereafter, the screens of the first touch panel 32 and the second touch panel 34 transition in the same manner as illustrated in FIG. 26.

As illustrated in FIG. 26, if the first customer before settlement operates the payment method selection screen SDa displayed on the second touch panel 34 to select a payment method desired by the first customer and pays a price, the screen of the second touch panel 34 transitions from the payment method selection screen SDa to the payment support screen SDc (or one of SDf and SDh) and further transitions to the payment check screen SDd (or one of SDg and SDi). Therefore, the customer only has to perform a deposit operation according to information of the screen displayed on the second touch panel 34. Accordingly, it is possible to provide a settlement device that can cause the customer himself or herself to perform operation concerning payment necessary for settlement of a transaction.

Moreover, while the screen of the second touch panel 34 is transitioning from the payment method selection screen SDa to the payment support screen SDc (or one of SDf and SDh) and to the payment check screen SDd (or one of SDg and SDi), the screen of the first touch panel 32 does not change from the total screen SCa. The total screen SCa is a screen for displaying information concerning the first customer and the second customer before settlement. Therefore, there is an advantage in that if the checker receives an inquiry from the first customer during settlement, the checker can easily determine, by viewing the total screen SCa, information concerning the first customer before the settlement.

As illustrated in FIG. 27, even if the store clerk operates the payment method selection screen SCb displayed on the first touch panel 32 to select a payment method desired by the customer, while the customer is paying a price with a payment method designated by the customer, the screen of the second touch panel 34 transitions to the payment support screen SDc (or one of SDf and SDh) and to the payment check screen SDd (or one of SDg and SDi). While the customer is paying the price, the total screen Sca is displayed on the first touch panel 32. Therefore, it is possible to provide a settlement device that can cause the customer himself or herself to perform an operation concerning payment necessary for settlement of a transaction excluding the operation for selecting a payment method and that enables the store clerk to easily check information concerning the customer before settlement.

### Other Embodiments

Information displayed in the first customer area ACa of the total screen SCa is not limited to the total number of items and the total price for the transaction of the first customer. Information displayed in the current area AAa, the details area Aab, and the total area Aac of the registration screen Saa displayed on the touch panel 23 of the input device 2 may be displayed in the first customer area Aca of the total screen Sca. Consequently, the store clerk can easily check detailed information about the transaction of the first customer before settlement. Information displayed in the second customer area ACb is not limited to the information illustrated in FIG. 14, either. For example, during registration, the number of registered items and a total price up to the present point in time may be displayed for the next customer. While waiting for the current customer to perform checkout, a total number of items and a total price are displayed for the next customer. Consequently, the store clerk can determine detailed information about a transaction for the second customer before settlement of the transaction for the first customer as well.

In an embodiment, the switch button BCa is disposed on the total screen SCa. However, according to other embodiments, there is no switch button BCa. That is, only the customer may be able to perform a selection operation for a payment method. Otherwise, other functionalities of such an embodiment may be the same as those of the embodiment described above.

The settlement device 3 illustrated in FIG. 1 generates, based on information concerning a purchase commodity, a commodity code and the like of which are input by the input device 2, generates sales data of the purchase commodity, and stores (registers) the sales data. In another embodiment of a settlement device, the keyboard 31, the first touch panel 32, or the handy scanner 33, an operator of which is a store clerk, is used as an input device. The settlement device receives information concerning a purchase commodity such as a commodity code via the input device, generates sales data of the purchase commodity based on the information, and stores the sale data. In an example, a customer himself or herself pays the price necessary for settlement of a transaction by operating the second touch panel 34, the printer 35, the automatic change machine 36, and the cashless settlement terminal 37 as in an embodiment explained above. That is, the settlement device may be what is referred to as a “two-way POS terminal”.

Several embodiments of the present disclosure have been explained. However, these embodiments are presented as examples and are not intended to limit the scope of the disclosure. Embodiments can be implemented in other various forms. Various omissions, substitutions, and changes can be performed without departing from the invention. These embodiments and modifications thereof are included in the scopes of the disclosure, the claims, and equivalents of the disclosure.

What is claimed is:

1. A settlement computing device, comprising:
a first display device capable of displaying information relevant to store clerks for settling transactions with customers;
a second display device capable of displaying information relevant to the customers for settling the transactions; and
a processor configured to:
acquire identifying information about a commodity to be purchased by a first customer as part of a first transaction; and
after acquiring the first information:
cause the first display device to display a total price required from the first customer as payment to complete the first transaction;
cause the second display device to display a first amount of money deposited by the first customer, without causing the first display device to display the first amount of money; and
determine whether a total amount of money deposited by the first customer is sufficient for settling the first transaction.

2. The settlement computing device according to claim 1, wherein the processor is further configured to:
before any money is deposited by the first customer, cause the first and second display devices to each display the total price.

3. The settlement computing device according to claim 1, wherein the processor is further configured to:
if the first amount of money is less than the total price, cause the second display device to display the difference between the first amount of money and the total price as a balance required to be deposited by the first customer to settle the first transaction; and
if the first amount of money is equal to or greater than the total price, cause the second display device to display the difference between the first amount of money and the total price as an amount of change due to be returned to the first customer.

4. The settlement computing device according to claim 3, wherein the processor is further configured to:
if the first amount of money is less than the total price, enable a button that is programmed to return the second display device to a state from before the deposit of the first amount of money was made; and
if the first amount of money is equal to or greater than the total price, disable the button.

5. The settlement computing device according to claim 4, wherein the button is displayed on the second display device.

6. The settlement computing device according to claim 1, wherein the processor is further configured to:
cause the second display device to display a group of payment method buttons, each payment method button of the group of payment method buttons designating a payment method for the first customer to complete the first transaction.

7. The settlement computing device according to claim 6, wherein the processor is further configured to:
cause the first display device to display a switch button programmed to enable a store clerk to intervene in selecting the payment method for the first customer; and
in response to the store clerk pressing the switch button, cause the first display device to display the group of payment method buttons.

8. The settlement computing device according to claim 1, wherein the processor is further configured to:
acquire identifying information about a commodity to be purchased by a second customer as part of a second transaction, before determining that the total amount of money deposited by the first customer is sufficient for settling the first transaction.

9. The settlement computing device according to claim 8, wherein the processor is further configured to:
cause the first display device to display a status of identifying commodities to be purchased by the second customer as part of the second transaction, before determining that the total amount of money deposited by the first customer is sufficient for settling the first transaction.

10. The settlement computing device according to claim 9, wherein the processor causes the first display device to display the total price required from the first customer, side by side with the status of identifying commodities to be purchased by the second customer.

11. A settlement method for a settlement device, the settlement device including a first display device capable of displaying information relevant to store clerks for settling transactions with customers and a second display device capable of displaying information relevant to the customers for settling the transactions, the settlement method comprising:
acquiring identifying information about a commodity to be purchased by a first customer as part of a first transaction; and
after acquiring the first information:
causing the first display device to display a total price required from the first customer as payment to complete the first transaction;
causing the second display device to display a first amount of money deposited by the first customer, without causing the first display device to display the first amount of money; and
determining whether a total amount of money deposited by the first customer is sufficient for settling the first transaction.

12. The settlement method according to claim 11, further comprising:
before any money is deposited by the first customer, causing the first and second display devices to each display the total price.

13. The settlement method according to claim 11, further comprising:
if the first amount of money is less than the total price, causing the second display device to display the difference between the first amount of money and the total price as a balance required to be deposited by the first customer to settle the first transaction; and
if the first amount of money is equal to or greater than the total price, causing the second display device to display the difference between the first amount of money and the total price as an amount of change due to be returned to the first customer.

14. The settlement method according to claim 13, further comprising:
if the first amount of money is less than the total price, enabling a button that is programmed to return the second display device to a state from before the deposit of the first amount of money was made; and
if the first amount of money is equal to or greater than the total price, disabling the button.

15. The settlement method according to claim 14, wherein the button is displayed on the second display device.

16. The settlement method according to claim 11, further comprising:
causing the second display device to display a group of payment method buttons, each payment method button of the group of payment method buttons designating a payment method for the first customer to complete the first transaction.

17. The settlement method according to claim 16, further comprising:
causing the first display device to display a switch button programmed to enable a store clerk to intervene in selecting the payment method for the first customer; and
in response to the store clerk pressing the switch button, causing the first display device to display the group of payment method buttons.

18. The settlement method according to claim 11, further comprising:
acquiring identifying information about a commodity to be purchased by a second customer as part of a second transaction, before determining that the total amount of money deposited by the first customer is sufficient for settling the first transaction.

19. The settlement method according to claim 18, further comprising:
causing the first display device to display a status of identifying commodities to be purchased by the second customer as part of the second transaction, before determining that the total amount of money deposited by the first customer is sufficient for settling the first transaction.

20. The settlement method according to claim 19, wherein the first display device is caused to display the total price required from the first customer, side by side with the status of identifying commodities to be purchased by the second customer.
